(19) United States
(12) Patent Application Publication
(10) Pub. No.: US 2019/0315121 A1
(43) Pub. Date: Oct. 17, 2019

(54) LIQUID DISCHARGE APPARATUS

(71) Applicant: BROTHER KOGYO KABUSHIKI KAISHA, Nagoya-shi (JP)

(72) Inventors: Yoshiharu FURUHATA, Nagoya-shi (JP); Shin HASEGAWA, Nagoya-shi (JP)

(21) Appl. No.: 16/385,014

(22) Filed: Apr. 16, 2019

(30) Foreign Application Priority Data
Apr. 16, 2018 (JP) 2018-078373

(51) Int. Cl. B41J 2/045; B41J 25/00

(52) U.S. Cl. CPC B41J 2/04573; B41J 25/006; B41J 2/04586

(57) ABSTRACT

A liquid discharge apparatus includes: a discharge head including nozzles; a head scanning mechanism that reciprocatingly moves the discharge head in a main scanning direction; a conveyer that conveys a recording medium in a sub-scanning direction; a controller; and a memory that stores image data of an image to be formed on the recording medium. In one pass, the controller executes: recording processing in which an image is formed on the recording medium by moving the discharge head in the main scanning direction and discharging liquid from the discharge head; setting processing in which the discharge head moves to a starting position of the recording processing for a pass following the one pass by changing a moving direction of the discharge head at a standstill position, without discharging the liquid from the discharge head; and conveyance processing in which the recording medium is conveyed in the sub-scanning direction.

### CROSS REFERENCE TO RELATED APPLICATION

The present application claims priority from Japanese Patent Application No. 2018-078373 filed on Apr. 16, 2018, the disclosure of which is incorporated herein by reference in its entirety.

### BACKGROUND

### Field of the Invention

The present invention relates to a liquid discharge apparatus configured to discharge a liquid such as ink.

### Description of the Related Art

There is conventionally known a liquid discharge apparatus that discharges a liquid such as ink and has a configuration as described in Japanese Patent Application Laid-open No. 2002-103595. In the liquid discharge apparatus, ink droplets are discharged from a recording head on a recording sheet while a carriage carrying the recording head moves in a main scanning direction. Then, the recording sheet is conveyed in a sub-scanning direction. Printing is performed on the entire surface of the recording sheet by repeating the movement including the discharge operation (printing operation) and the conveyance of the recording sheet (conveyance operation) multiple times.

### SUMMARY

In a case of image formation, the carriage reciprocates in the main scanning direction. The movement of the carriage generates airflow in the vicinity of the carriage. When the carriage moves in a first direction along the main scanning direction, the airflow generated by the previous movement in a second direction opposite to the first direction of the carriage remains. This airflow may shift a landing position of each liquid droplet discharged at the time of start of the operation in which the carriage moves in the first direction. Further, printing with higher resolution is required in recent years. In order to meet this demand, liquid droplets having a small size (diameter) are often used, and thus a measure to solve the landing failure of liquid droplets due to the airflow is needed.

In view of the above, an object of the present teaching is to provide a liquid discharge apparatus that is capable of inhibiting an effect of airflow caused by movement of a discharge head on a landing position of each liquid droplet discharged from the discharge head.

According to an aspect of the present teaching, there is provided a liquid discharge apparatus, including: a discharge head including a plurality of nozzles; a head scanning mechanism configured to reciprocatingly move the discharge head in a main scanning direction; a conveyer configured to convey a recording medium in a sub-scanning direction orthogonal to the main scanning direction; and a controller configured to control the discharge head, the head scanning mechanism, and the conveyer; wherein the controller is configured to execute, in one pass, recording processing in which an image is formed on the recording medium by moving the discharge head in the main scanning direction and discharging liquid from the discharge head, setting processing, taking setting processing time and executed after completion of the recording processing, in which the discharge head is moved from an ending position of the recording processing for the one pass to a starting position of the recording processing for a pass following the one pass by changing a moving direction of the discharge head at a standstill position, without discharging the liquid from the discharge head, and conveyance processing in which the recording medium is conveyed in the sub-scanning direction, wherein the controller is further configured to: set the setting processing time required for the setting processing for the one pass as a first setting time in a case that the pass following the one pass is a first state pass, and set the setting processing time required for the setting processing for the one pass as a second setting time in a case that the pass following the one pass is a second state pass, the second setting time being obtained by adding a waiting time to the first setting time, the second state pass being different from the first state pass.

According to the aspect of the present teaching, when the landing failure of liquid droplets due to residual airflow is highly likely to be caused at the time of start of the recording processing for the pass following the one pass, the setting processing time is set as the second setting time longer than normal (the first setting time). This weakens the airflow, which is generated when the discharge head moves to the standstill position for changing the moving direction in order to execute the recording processing for the pass following the one pass, to an extent that the airflow has no effect on the landing of liquid droplets at the time of start of the recording processing for the pass following the one pass. The deterioration in image due to the airflow can thus be inhibited.

The present teaching provides the liquid discharge apparatus that is capable of inhibiting an effect of airflow generated by movement of the discharge head on a landing position of each liquid droplet discharged from the discharge head.

### BRIEF DESCRIPTION OF THE DRAWINGS

FIG. 1 schematically depicts a configuration of a liquid discharge apparatus according to a first embodiment of the present teaching.

FIG. 2 is a block diagram depicting a functional configuration of the liquid discharge apparatus.

FIG. 3 depicts a recording sheet and a liquid discharge head when the liquid discharge apparatus is seen from above.

FIG. 4 is a flowchart indicating basic operations of print processing.

FIG. 5 schematically illustrates operations of the liquid discharge head during the print processing.

FIG. 6 is a flowchart indicating a procedure for setting a setting processing time.

FIGS. 7A to 7C each depict an exemplary operation of the liquid discharge head during the setting processing.

FIGS. 8A and 8B are a flowchart indicating another procedure for setting the setting processing time.

### DESCRIPTION OF THE EMBODIMENTS

### First Embodiment

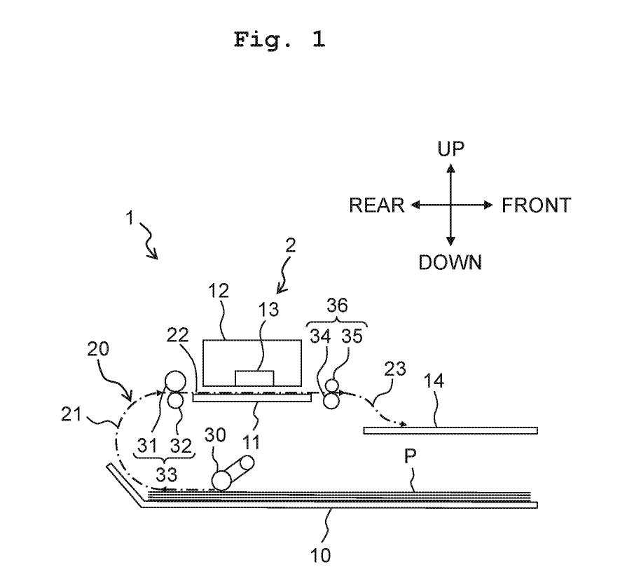

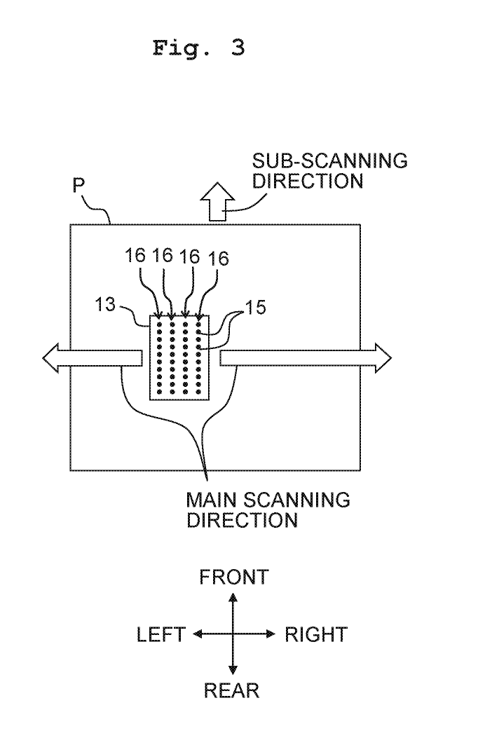

Referring to drawings, a liquid discharge apparatus according to an embodiment of the present teaching is explained below. In the following explanation, an ink discharge apparatus configured to discharge ink on a recording sheet is an exemplary liquid discharge apparatus. In the present specification, front, rear, right, left, up, and down are defined as depicted in FIGS. 1 and 3.

<Configuration of Liquid Discharge Apparatus>

As depicted in FIG. 1, a liquid discharge apparatus 1 includes a feed tray 10, a platen 11, a carriage 12, and the like. The feed tray 10 accommodates multiple recording sheets P. The platen 11 is long in the left-right direction and is provided above the feed tray 10. The platen 11 is a flat plate member and supports, from below, the recording sheet P being conveyed. The carriage 12 is disposed above the platen 11. The carriage 12 carries a liquid discharge head 13 and the like and reciprocates in the left-right direction. A discharge tray 14 is provided in front of the platen 11 to receive the recording sheet P for which recording has been performed.

A sheet conveyance path 20 extends from the rear side of the feed tray 10. The sheet conveyance path 20 connects the feed tray 10 and the discharge tray 14. The sheet conveyance path 20 can be divided into three paths, which are a curved path 21, a straight path 22, and an end pass 23. The curved path 21 curves upward from the feed tray 10 to reach the vicinity of a rear portion of the platen 11. The straight path 22 extends from an end or terminal of the curved path 21 to reach the vicinity of a front portion of the platen 11. The end path 23 extends from an end or terminal of the straight path 22 to the discharge tray 14.

The liquid discharge apparatus 1 includes, as a sheet conveyer configured to convey the recording sheet P, a feed roller 30, a conveyance roller 31, and a discharge roller 34. The sheet conveyer conveys each recording sheet P accommodated in the feed tray 10 to the discharge tray 14 along the sheet conveyance path 20.

Specifically, the feed roller 30 is disposed immediately above the feed tray 10 and makes contact with the uppermost recording sheet P from above. The conveyance roller 31 and a pinch roller 32 form a conveyance roller unit 33, which is disposed in the vicinity of a downstream end of the curved path 21. The conveyance roller unit 33 connects the curved path 21 and the straight path 22. The discharge roller 34 and a spur roller 35 form a discharge roller unit 36, which is disposed in the vicinity of a downstream end of the straight path 22. The discharge roller unit 36 connects the straight path 22 and the end path 23.

Each recording sheet P is supplied to the conveyance roller unit 33 via the curved path 21 by use of the feed roller 30. Then, the recording sheet P is sent through the straight path 22 to the discharge roller unit 36 by use of the conveyance roller unit 33. In the straight path 22, ink is discharged from the liquid discharge head 13 to the recording sheet P on the platen 11, thus recording an image on the recording sheet P. The recording sheet P for which recording has been performed is conveyed to the discharge tray 14 by use of the discharge roller unit 36.

The liquid discharge apparatus 1 includes, as a head scanning mechanism that causes the liquid discharge head 13 to reciprocate, the carriage 12, a guide member (not depicted), and an endless belt (not depicted). The head scanning mechanism causes the liquid discharge head 13 to reciprocate in the left-right direction across the straight pass 22 of the sheet conveyance path 20.

Specifically, the guide member of the head scanning mechanism is two support bars parallel to each other. The support bars are arranged orthogonal to the front-rear direction. The carriage 12 is slidably attached to the support bars. The endless belt is disposed parallel to the support bars. The carriage 12 is fixed to the endless belt. Rotation of a carriage motor 51 (described below) causes the endless belt to run, thus moving the carriage 12 along the support bars.

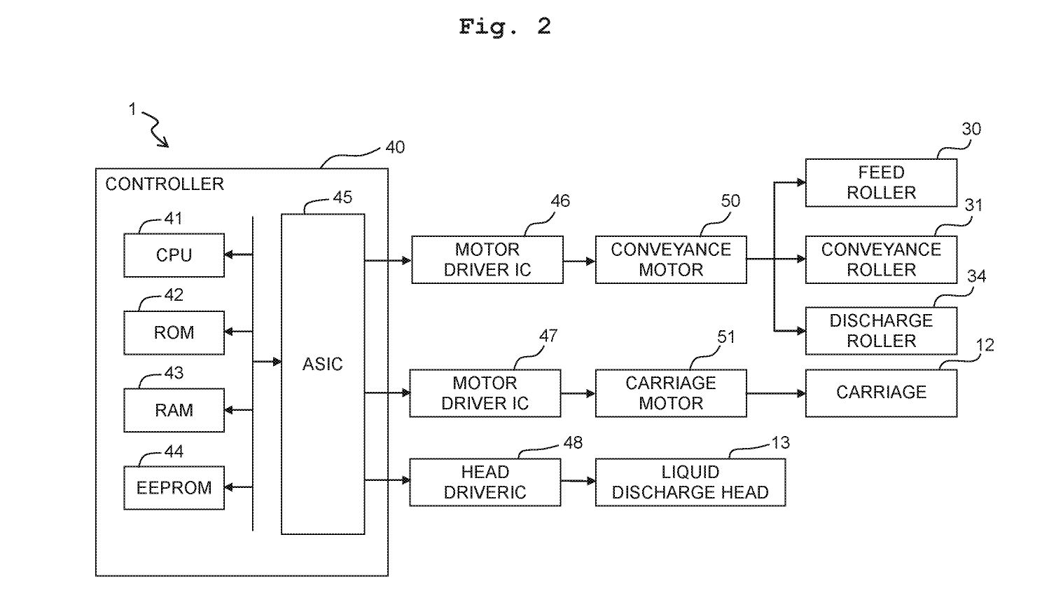

Referring to FIG. 2, a functional configuration of the liquid discharge apparatus 1 is explained below. A controller 40 of the liquid discharge apparatus 1 includes a first substrate and a second substrate. The first substrate mounts a CPU 41, a ROM 42, a RAM 43 (an exemplary memory), and an EEPROM 44. The second substrate mounts an ASIC 45. The ASIC 45 is connected to a motor driver IC 46, a motor driver IC 47, and a head driver IC 48. The motor driver IC 46 drives a conveyance motor 50, and the motor driver IC 47 drives the carriage motor 51. The head driver IC 48 drives an actuator of the liquid discharge head 13.

When the controller 40 of the liquid discharge apparatus 1 receives input of a printing job from a user or another communication apparatus, the CPU 41 causes the RAM 43 to memory image data related to the printing job and the CPU 41 outputs a command for executing the printing job to the ASIC 45 in accordance with a program stored in the ROM 42. The ASIC 45 controls each of the driver ICs 46 to 48 based on this command to execute print processing based on the image data memorized in the RAM 43.

In the print processing, the motor driver IC 46 drives the conveyance motor 50 to rotate the feed roller 30, the conveyance roller 31, and the discharge roller 34. The motor driver IC 47 drives the carriage motor 51 to cause the carriage 12 to reciprocate in the left-right direction (a main scanning direction). The head driver IC 48 drives the actuator to generate meniscus vibration or oscillation, to discharge ink, and the like.

The liquid discharge apparatus 1 includes a variety of sensors (e.g., a front-end detection sensor for detecting a position of the recording sheet and an encoder for detecting a position of the carriage). The controller 40 controls the driver ICs 46 to 48 based on signals from the above sensors so that the driver ICs 46 to 48 are synchronized to each other, thus forming an image on the recording sheet P.

The carriage motor 51, the carriage 12, the guide member, and the endless belt form the head scanning mechanism of the present teaching. The head scanning mechanism causes the liquid discharge head 13 to reciprocate in the main scanning direction. The conveyance motor 50, the feed roller 30, the conveyance roller 31, and the discharge roller 34 form the conveyer of the present teaching. The sheet conveyer conveys the recording sheet P on the platen 11 in a sub-scanning direction.

As depicted in FIG. 3, a lower surface of the liquid discharge head 13 faces the recording sheet P. The lower surface is a nozzle surface in which nozzles 15 are open. The nozzles 15 are aligned in the sub-scanning direction (front-rear direction) to form each nozzle row 16. The nozzle rows 16 are arranged in the main scanning direction at intervals. In the first embodiment, the respective nozzle rows 16 correspond to different kinds of liquids, which are, for example, black, yellow, cyan, and magenta inks.

The liquid discharge apparatus 1 alternately repeats scanning of the carriage 12 and conveyance of the recording sheet P, thus recording (forming) an image on the entire surface of the recording sheet P.

The moving path of the carriage 12 extends from one side in the main scanning direction of a conveyance area of the recording sheet P to the other with the recording area interposed therebetween. The liquid discharge apparatus 1 includes a storing position of the liquid discharge head 13 on one side in the main scanning direction. When the liquid discharge apparatus 1 is turned off, the liquid discharge head 13 is stored in the storing position and the nozzle surface is covered with a cap. A maintenance position of the liquid discharge head 13 is provided on the other side in the main scanning direction where maintenance (flushing or purge) is executed on the liquid discharge head 13.

<Operation Flow in Printing>

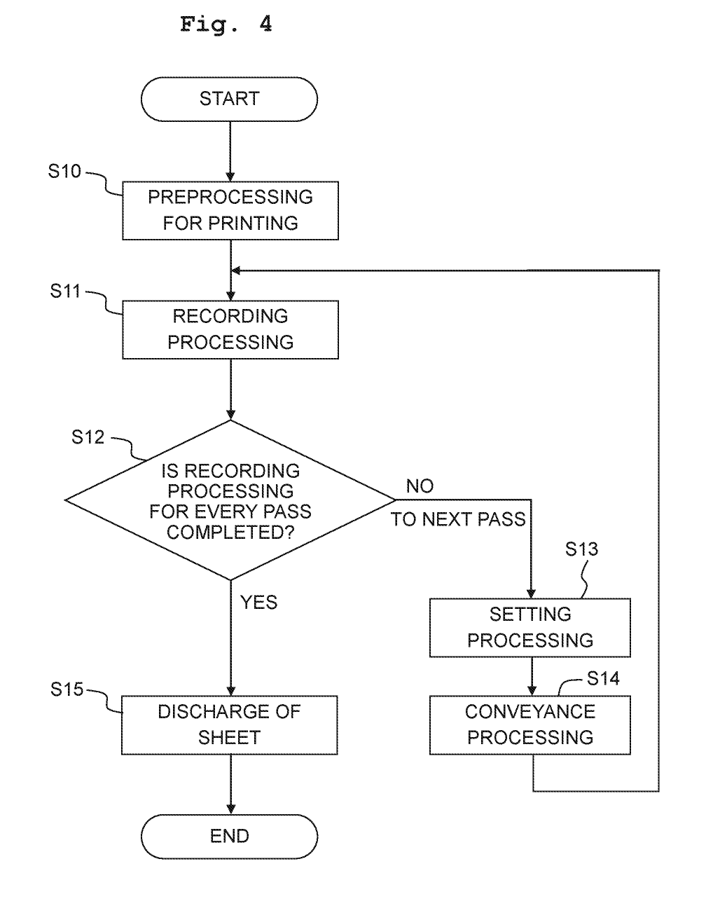

Subsequently, the print processing executed by the liquid discharge apparatus 1 is explained. Referring to FIG. 4, a flow of the print processing executed on one recording sheet P is explained below.

As depicted in FIG. 4, when receiving a printing job, the controller 40 executes preprocessing for printing (step S10). In the step S10, the controller 40 adjusts meniscuses and generates recording data.

The controller 40 removes the cap from the nozzle surface and moves the liquid discharge head 13 from the storing position to the maintenance position. In the maintenance position, the liquid discharge head 13 is driven to execute the flushing (recovery operation of discharge performance) predetermined number of times. This results in newly-made meniscuses in the nozzles 15.

Then, the controller 40 drives the carriage motor 51 to move the liquid discharge head 13 in a direction toward the storing position (referred to as a first direction). In that situation, the liquid discharge head 13 accelerates to a predefined velocity before arriving at the first discharge position (a starting point of the first pass).

In the movement of the liquid discharge head 13 toward the storing position, the controller 40 memorizes image data in the RAM 43. The controller 40 generates the recording data for the first pass based on the image data, and memorizes it in the RAM 43. The controller 40 generates recording data for each pass until the image formation on the entire surface of one recording sheet P is completed.

Then, the controller 40 feeds the first recording sheet P from the feed tray 10 and supplies it to the straight pass 22. The timing at which the feed processing is executed is matched with the timing at which meniscus adjustment and/or the generation of recording data is/are executed.

When the liquid discharge head 13 has arrived at the starting point of the first pass, the controller 40 starts processing related to the first pass. In the first pass, the controller 40 discharges the liquid from each nozzle 15 while moving the liquid discharge head 13 in the first direction. A strip-like or belt-like image is formed on the recording sheet P (step S11).

One pass in the print processing is a series of processing including one recording processing and one setting processing (described below).

In one recording processing, the controller 40 moves the liquid discharge head 13 toward any one direction (the first direction in this example) included in the main scanning direction. The controller 40 discharges the liquid from each nozzle 15 in synchronization with this movement. Synchronizing the movement of the liquid discharge head 13 with the discharge of liquid is executed based on the signal from the encoder. As described above, one recording processing is a discharge operation executed during the movement of the liquid discharge head 13 in the first direction, and it is continuously executed from the first discharge position to the last discharge position.

When completing the first recording processing (S11), the controller 40 determines whether the recording processing for every pass to be executed in the printing job is completed (step S12). If the recording processing is not completed (S12: NO), the controller 40 executes the setting processing (step S13) and conveyance processing (step S14) to execute the recording processing for the succeeding pass.

The setting processing (S13) is processing in which the liquid discharge head 13 moves to a starting position of the recording processing for the succeeding pass after completion of the recording processing for the pass executed immediately before the succeeding pass. In the setting processing, the liquid discharge head 13 moves in a state where no liquid is discharged (referred to as a non-discharge state). This movement includes one reverse movement of the liquid discharge head 13 from the first direction to a second direction. The conveyance processing (S14) is processing in which the recording sheet P is conveyed in the sub-scanning direction. When the liquid discharge head 13 moves in the first direction after the conveyance processing, the liquid discharge head 13 is capable of passing the starting position of the recording processing for the succeeding pass.

For the purpose of convenience, FIG. 4 serially indicates the setting processing and the conveyance processing in that order. The conveyance processing, however, may be started and completed while the setting processing is being executed. Then, the controller 40 executes again the recording processing (S11) from the starting point for the succeeding pass.

The controller 40 repeatedly executes the series of processing in steps S11 to S14. When the recording processing for every pass is completed (S12: YES), the controller 40 controls the sheet conveyer to discharge the recording sheet P on the discharge tray 14 (step S15). Accordingly, the print processing for one recording sheet P is completed.

When printing is needed to be continuously executed on another recording sheet P, the controller 40 returns to the step S10. Then, the controller 40 executes the preprocessing for printing to generate new recording data and supply the recording sheet P. The meniscus adjustment is executed as needed. Then, the controller 40 proceeds to the step S11.

When no printing is needed to be executed on another recording sheet P, the controller 40 ends the print processing. For example, the liquid discharge head 13 returns to the storing position and the nozzle surface is covered with the cap. The nozzle surface may be cleaned to remove dirt or meniscus adjustment may be executed before the liquid discharge head 13 is stored in the storing position.

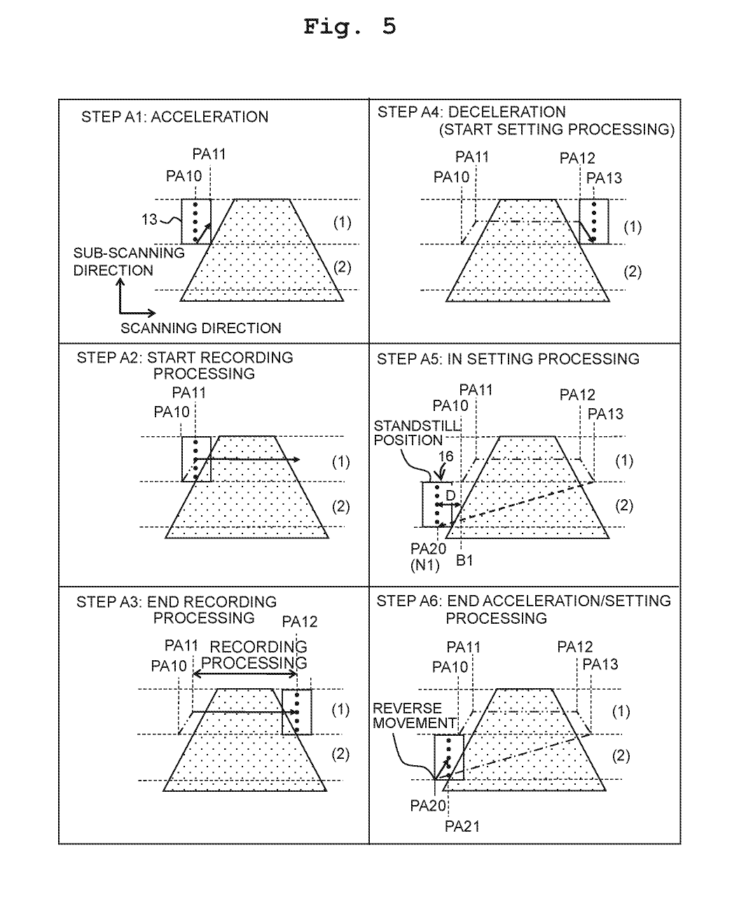

Referring to FIG. 5, operations of the liquid discharge head 13 during image formation is explained below. The explanation begins with one recording processing in the middle of the image formation. As depicted in FIG. 5, an image subjected to the image formation is a trapezoid filled with dots. The image is formed by unidirectional printing. In the unidirectional printing, the recording processing is executed only when the liquid discharge head 13 moves in the first direction.

In FIG. 5, obliquely upward arrows mean that the carriage 12 accelerates, obliquely downward arrows mean that the carriage 12 decelerates, and horizontal arrows mean that the carriage 12 moves at constant velocity. FIG. 5 includes six steps A1 to A6 in chronological order, and each of the steps A1 to A6 illustrates the operation of printing of the trapezoid.

In the step A1, the liquid discharge head 13 is in a standstill or stop position PA10. The position PA10 is a direction change position where the moving direction of the liquid discharge head 13 is changed. Although not depicted in FIG. 5, the moving direction of the liquid discharge head 13 has changed from the second direction to the first direction at the position PA10. In the setting processing, the position PA10 is a position through which the liquid discharge head 13 passes.

The position PA10 is separated in the second direction from a starting position PA11 of the recording processing by a predefined distance (a distance required for acceleration of the liquid discharge head 13). The liquid discharge head 13 accelerates and moves from the position PA10 to the position PA11. The acceleration rate of the liquid discharge head 13 is fixed.

In the step A2, the liquid discharge head 13 is in the position PA11. The position PA11 is not only an ending point of the preceding pass but also a starting point of the succeeding pass (pass (1)). The liquid discharge head 13 starts the recording processing at the position PA11. The liquid discharge head 13 moves in the first direction at constant velocity and the liquid is discharged from each nozzle 15. Accordingly, a partial image of the trapezoid is printed on the recording sheet P (not depicted).

In the step A3, the liquid discharge head 13 is in a position PA12. The position PA12 is not only an ending point of the recording processing for the pass (1) but also a starting point of the setting processing for the pass (1). The partial image of the trapezoid is completed when the liquid discharge head 13 has arrived at the position PA12, and the discharge of liquid from each nozzle 15 is stopped.

Regarding the partial image formed in the pass (1) in which the liquid discharge head 13 moves in the first direction, the position PA11 is a position where a pixel corresponding to a first end of the partial image is formed and the position PA12 is a position where a pixel corresponding to a second end of the partial image is formed.

In the step A4, the liquid discharge head 13 decelerates from the position PA12 to a position PA13. The deceleration rate of the liquid discharge head 13 is fixed. The liquid discharge head 13 stops at the position PA13. The position PA13 is the first direction change position in the unidirectional printing. As depicted in the step A5, the liquid discharge head 13 passes across the formed partial image and moves to the opposite side at once.

In the step A5, the liquid discharge head 13 is in a position PA20 after moving to the opposite side at once. The position PA20 is the second direction change position in the unidirectional printing where the liquid discharge head 13 temporarily stops. The position PA20, which is a position corresponding to the position PA10, is separated in the second direction from a position PA21 by a predefined distance (a distance required for acceleration of the liquid discharge head 13).

In the step A6, the liquid discharge head 13 is in the position PA21. The position PA21 is not only an ending point of the pass (1) but also a starting point of a pass (2) subsequent to the pass (1). The liquid discharge head 13 reverses the moving direction at the position PA20, and accelerates and moves in the first direction to the position PA21. The acceleration rate of the liquid discharge head 13 is fixed.

When the liquid discharge head 13 has arrived at the position PA21, the liquid discharge head 13 starts the recording processing for the pass (2) similarly to the case in which the liquid discharge head 13 has arrived at the position PA11 in the pass (1) (see the steps A2 and A3). As described above, the liquid discharge apparatus 1 executes, for example, acceleration, movement at constant velocity, liquid discharge, deceleration, and two reverse movements of the liquid discharge head 13 during one pass. One image is recorded by repeating them.

The operations depicted in the steps A2 and A3 of FIG. 5 correspond to the recording processing (S11) in FIG. 4. The recording processing is an operation executed in one pass from the discharge of the first liquid droplet through the discharge of the last liquid droplet. The liquid discharge head 13 moves at fixed velocity and discharges the liquid in synchronization with this movement to form the partial image.

The operations depicted in the steps A4 to A6 of FIG. 5 correspond to the setting processing (S13) in FIG. 4. The setting processing is an operation after the recording processing for one pass is completed until the recording processing for the next pass is started. The liquid discharge apparatus 1 executes, for example, deceleration, two changes in the moving direction, and acceleration of the liquid discharge head 13 to continuously execute two recording processings.

<Setting of Setting Processing Time>

As described above, the liquid discharge apparatus 1 executes one setting processing before one recording processing is started to move the liquid discharge head 13 to the starting position of said one recording processing. The liquid discharge head 13 moves in the first direction in the recording processing, and then moves in the opposite direction in the setting processing. Thus, airflow caused in the setting processing may affect each liquid droplet discharged in the recording processing immediately after the setting processing, which may shift the landing position of each liquid droplet.

In the first embodiment, in order to inhibit the landing failure of each liquid droplet due to the airflow, the time spent on the setting processing (hereinafter referred to as setting processing time) is appropriately adjusted based on image data.

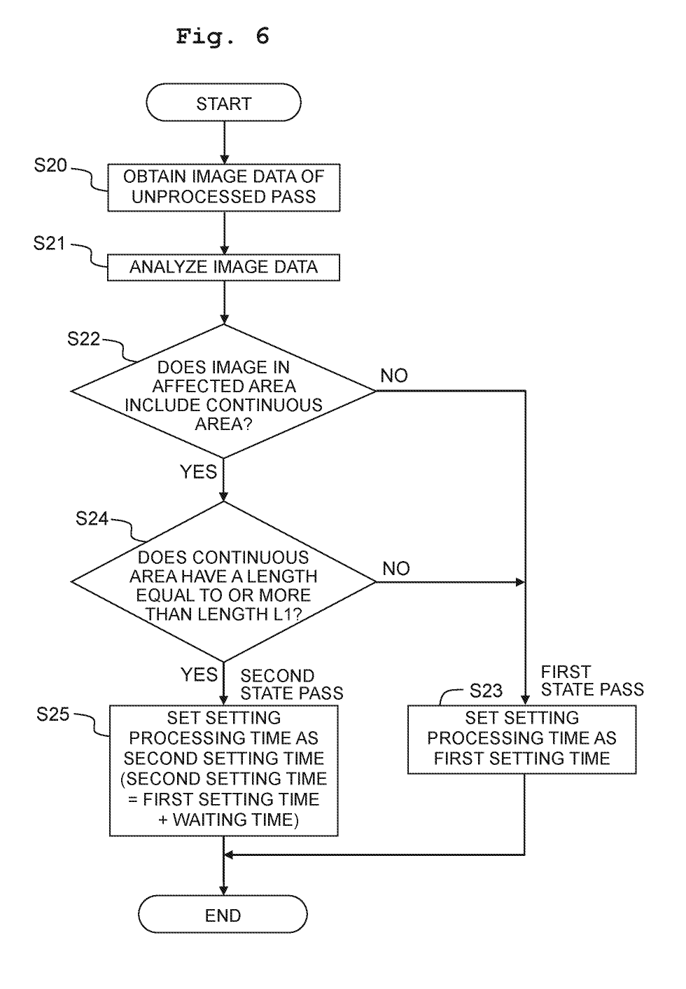

Referring to FIG. 6, a procedure for setting the setting processing time is explained. The controller 40 first (step S20) obtains image data of an unprocessed pass. The image data of the unprocessed pass typically corresponds to image data for the next recording processing. In the step S21, the controller 40 analyzes the image data to extract a continuous area. In a step S22, the controller 40 determines whether an image in an affected area includes the continuous area.

In order to perform printing with high throughput, the setting processing time is preferably short. Thus, in the setting processing, the liquid discharge head 13 has great acceleration and deceleration rates before and after the standstill position and moves at high velocity when no liquid is discharged. When the recording processing is executed, however, the airflow caused in the setting processing immediately before the recording processing remains. The airflow would affect the liquid(s) discharged in the recording processing, thereby leading to the landing failure.

The affected area is an area in which the airflow causing a recognizable landing shift remains when the recording processing is executed without adjusting the setting processing time. The affected area is an area from a nozzle position to a boundary position. Here, the nozzle position is a position in the main scanning direction of each nozzle row 16 when the liquid discharge head 13 is in the standstill position. The boundary position is a position separated, by a predefined distance D, from the nozzle position in a moving direction (e.g., the first direction) of the liquid discharge head 13 after the change in the moving direction.

Referring to the step A5 of FIG. 5, the affected area is further explained below. In the pass (2), a nozzle position N1 is a position of the nozzle row 16 when the liquid discharge head 13 is in the standstill position PA20. A boundary position B1 is a position separated from the nozzle position N1 in the first direction (the direction directed from the standstill position PA20 to the starting position PA21) by the predefined distance D. If the starting position PA21 is in the predefined distance D, the landing failure may occur in an area where printing is started.

In the first embodiment, the affected area is determined in advance. The affected area is determined as follows.

The liquid discharge apparatus 1 records a test pattern in the first direction. For example, the test pattern includes multiple line segments (the length in the sub-scanning direction: 35 mm, the length in the main scanning direction: 1 mm). Each line segment is formed using a liquid droplet size of 2 pl. The residual airflow shifts the liquid droplet toward the second direction with respect to the line segment, forming a dot affected. by the landing failure. In the first embodiment, a sampling field is set in the second direction with respect to the line segment, and the number of failure dots in the field is counted. Each sampling field is a rectangular area having a length in the sub-scanning direction of 10 mm and a length in the main scanning direction of 5 mm. Each sampling field is separated from the corresponding line segment at an interval of 0.5 mm.

The number of dots in the sampling field decreases with distance from the standstill position PA20 (the position having a distance of 10 mm from the nearest line segment). In the first embodiment, a position of the line segment having a dot count value of less than 15 in the corresponding sampling field is set as the boundary position B1.

The continuous area of the image is an area formed by multiple pixels, which correspond to resolution in the sub-scanning direction of the image and are arranged at unit intervals. The continuous area of the image is a partial image in which multiple pixels are continuously arranged in the sub-scanning direction.

When the continuous area is not included in the affected area (S22: NO), the controller 40 sets the setting processing time as a first setting time (step S23). When the continuous area is in the affected area (S22: YES), the controller 40 proceeds to a step S24.

In the step S24, the controller 40 determines whether the continuous area has a length equal to or more than a length L1 in the sub-scanning direction. When the length in the sub-scanning direction of the continuous area is less than the length L1 (S24: NO), the controller 40 sets the setting processing time as the first setting time (S23). When the length in the sub-scanning direction of the continuous area is equal to or more than the length L1. (S24: YES), the controller 40 proceeds to a step S25.

In the step S25, the controller 40 sets the setting processing time as a second setting time (=the first setting time+waiting time), which is longer than the first setting time.

In the following, for the purpose of convenience, the pass may be referred to as a first state pass or a second state pass.

The first state pass is a processing pair continuing from the recording processing to the setting processing. The setting processing time in the setting processing immediately before the first state pass is the first setting time. The residual airflow caused by the setting processing immediately before the first state pass would have a relatively small effect on the landing position of the liquid droplet in the first state pass. The setting processing time is thus not required to be adjusted in the setting processing immediately before the first state pass.

The second state pass is a processing pair continuing from the recording processing to the setting processing. The setting processing time in the setting processing immediately before the second state pass is the second setting time. If the setting processing time in the setting processing immediately before the second state pass is the first setting time, the residual airflow caused by the setting processing immediately before the second state pass would have a relatively large effect on the landing position of the liquid droplet in the second state pass. The setting processing time is thus required to be adjusted in the setting processing immediately before the second state pass.

As described above, when the continuous area of which length in the sub-scanning direction is equal to or more than the length L1 is included in the affected area for the next pass (i.e., when the next pass is the second state pass), the setting processing immediately before the recording processing is executed using the second setting time. Accordingly, the recording processing is executed in a state where the residual airflow caused by the setting processing is weak. This hardly causes the landing failure due to the airflow.

When the continuous area of which length in the sub-scanning direction is less than the length L1 is included in the affected area for the next pass (i.e., when the next pass is the first state pass), the landing failure to be caused would be inconspicuous. The setting processing time is thus set to the first setting time, speeding up the print processing.

When the continuous area is present, the setting processing time is set to the second setting time. When multiple pixels are not continuously arranged in the sub-scanning direction, the landing failure to be caused would be inconspicuous. The setting processing time is thus set to the first setting time. Accordingly, the setting processing time is not unnecessarily lengthened, speeding up the print processing.

In the first embodiment, the length L1 may be set to, for example, 1.0 mm. In that case, if the continuous area included in the affected area has a length of less than the length L1, the landing failure to be caused would be inconspicuous. This allows the setting processing time to be set to the first setting time, speeding up the print processing.

<Exemplary Operation in Setting Processing>

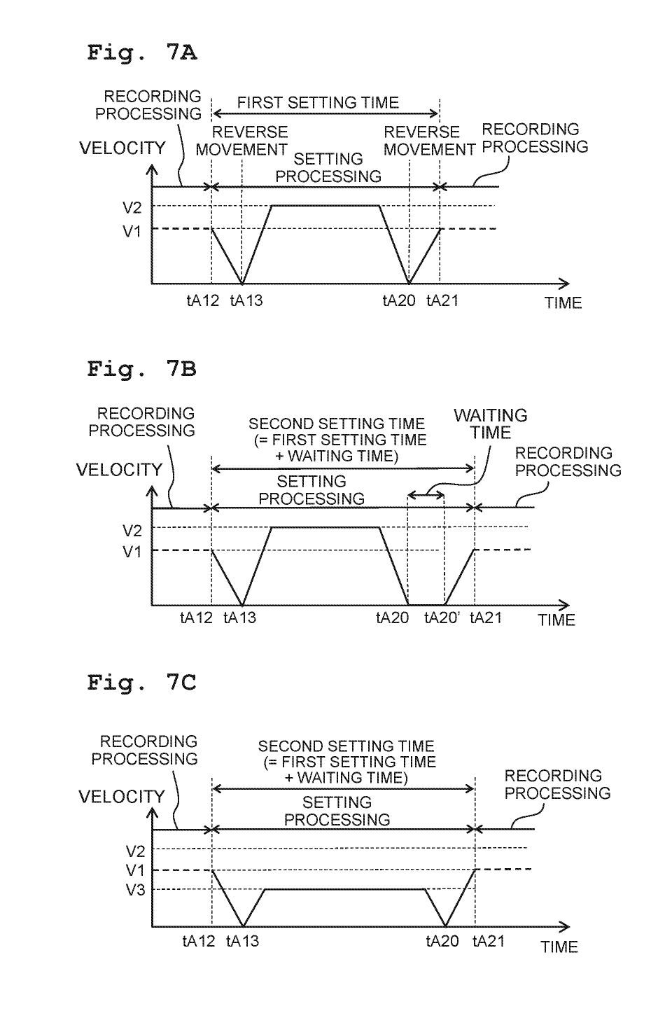

Referring to FIGS. 7A to 7C, exemplary operations of the liquid discharge head 13 in the setting processing are explained below. In FIGS. 7A to 7C, the time, which is indicated by the horizontal axis, also indicates the position of the liquid discharge head 13 at the time. For example, the number included in a time tA12 (12 in the time tA12) corresponds to the position PA12 in FIG. 5 having the identical number. Namely, each of the times tA12, tA13, tA20, and tA21 in FIGS. 7A to 7C indicates the time at which the liquid discharge head 13 has arrived at the corresponding one of the positions PA12, PA13, PA20, and PA21 in FIG. 5.

FIG. 7A is an exemplary operation when the setting processing time is set to the first setting time. Namely, a pass executed immediately after this setting processing is the first state pass. Even when the first setting time is set as the setting processing time, the recording processing immediately after this setting processing does not have a conspicuous landing failure due to the airflow. This operation is explained below referring to FIG. 5 and FIG. 7A.

In the recording processing, the liquid discharge head 13 moves in the first direction at a velocity V1, reaches the position PA12 at the time tA12, and the recording is completed. In the setting processing immediately after the recording processing, the liquid discharge head 13 decelerates, reaches the position PA13 at the time tA13, and stops. The position PA13 is the first direction change position.

The liquid discharge head 13 reverses the moving direction immediately after the liquid discharge head 13 stops at the position PA13, and accelerates to a velocity V2 (V2>V1) and moves in the second direction. The liquid discharge head 13 decelerates during movement at the velocity V2, reaches the position PA20 at the time tA20, and stops. The position PA20 is the second direction change position.

The liquid discharge head 13 reverses the moving direction immediately after the liquid discharge head 13 stops at the position PA20, and accelerates to the velocity V1 and moves in the first direction. The liquid discharge head 13 has the velocity A1 at the time tA21 and at the same time, the liquid discharge head 13 arrives at the position PA 21 where the setting processing is completed. The position PA21 is also a starting position of the recording processing for the next pass. In that case, the time from the starting time tA12 to the ending time tA21 of the setting processing is the first setting time.

FIG. 7B is an exemplary operation when the setting processing time is set to the second setting time. In this exemplary operation, the setting processing includes waiting processing. Namely, the pass executed immediately after this setting processing is the second state pass. If the first setting time is set as the setting processing time, the recording processing immediately after this setting processing has a conspicuous landing failure due to the airflow.

The operation executed at the second direction change position (position PA20) of the example depicted in FIG. 7B is different from that of the example depicted in FIG. 7A in which the setting processing time is set to the first setting time. In the operation depicted in FIG. 7B, the liquid discharge head 13 stops at the time tA20 (position PA20) and then executes the waiting processing. In the waiting processing, the liquid discharge head 13 stops at the standstill position PA20 during a waiting time tA20 to tA20′.

Namely, the liquid discharge head 13 does not move and waits at the position PA20 until the residual airflow weakens. Subsequent operations are the same as those of the case in which the setting processing time is set to the first setting time. In the example depicted in FIG. 7B, the time from the starting time tA12 to the ending time tA21 of the setting processing is the second setting time (=the first setting time+waiting time).

As described above, in the exemplary operation depicted in FIG. 7B, the liquid discharge head 13 waits at the second direction change position (standstill position PA20) in the unidirectional printing. The waiting processing weakens the residual airflow caused by the setting processing. The landing failure of liquid droplets is thus inhibited in the recording processing immediately after the waiting processing.

The waiting time is preferably in a range of equal to or more than 0.1 second and equal to or less than 1.0 seconds to sufficiently weakens the airflow and not to lengthen the print processing.

In the waiting processing, the liquid discharge head 13 may not completely stop at the standstill position PA20. For example, the liquid discharge head 13 may move in the vicinity of the standstill position PA20 during the waiting processing to such an extent that the landing failure is not caused in the recording processing immediately after the waiting processing. This movement in the vicinity of the standstill position PA20 during the waiting processing includes, for example, microvibration and slow reciprocating movement in the main scanning direction.

FIG. 7C is another exemplary operation when the setting processing time is set to the second setting time. In the example depicted in FIG. 7C, the setting processing is executed at low velocity overall and the waiting processing is not included in the setting processing. The waiting processing, however, may be included in the setting processing, and in that case, the airflow is further securely weakened.

The pass executed immediately after this setting processing is the second state pass. When the setting processing time of this setting processing is set to the first setting time, the recording processing immediately after this setting processing has a conspicuous landing failure due to the airflow.

The operation executed between the direction change positions (between the position PA13 and the position PA20) of the example depicted in FIG. 7C is different from that of the example in which the setting processing time is set to the first setting time. In the example depicted in FIG. 7C, the average movement velocity of the liquid discharge head 13 is low and the movement time during which the liquid discharge head 13 moves between the direction change positions is long.

The setting processing of the example depicted in FIG. 7C is executed similarly to the example depicted in FIG. 7A from the time tA12 to the time tA13. Then, the liquid discharge head 13 reverses the moving direction at the position PA13 corresponding to the time tA13 and accelerates to a velocity V3 (V2>V3). The liquid discharge head 13 decelerates during the movement at the velocity V3 and reaches the PA20 at the time tA20.

Namely, the liquid discharge head 13 moves slowly between the direction change positions, thus making the airflow weak. Subsequent operations are the same as those of the case in which the setting processing time is set to the first setting time. In the example depicted in FIG. 7C, the time from the starting time tA12 to the ending time tA21 of the setting processing is the second setting time (=the first setting time+waiting time).

As described above, when the next pass is the second state pass, the liquid discharge head 13 may move at lower velocity in the setting processing without involving the waiting processing. Since the airflow caused in the setting processing is weak, the landing failure of liquid droplets is not likely to occur in the next recording processing. The section in which the liquid discharge head 13 is moved at lower velocity is not limited to the section between the position PA13 and the position PA20. For example, the liquid discharge head 13 may be moved at lower velocity in the section between the position PA12 and the position PA13 or the section between the position PA20 and the position PA21, as compared with the case in which the setting processing time is set to the first setting time. In other words, the movement time during which the liquid discharge head 13 moves between the position PA12 and the position PA13 may be long, or the movement time during which the liquid discharge head 13 moves between the position PA20 and the position PA21 may be long, as compared with the case in which the setting processing time is set to the first setting time.

The exemplary operations of the liquid discharge head 13 in the setting processing are not limited to the above. For example, the moving velocity of the liquid discharge head 13 in the second direction may not be fixed, and the liquid discharge head 13 may move at lower velocity as time passes (as the liquid discharge head 13 approaches the standstill position PA20).

<Measure to Solve Thickening of Liquid>

When the setting processing time is set to be long (the second setting time in the first embodiment), a time during which the liquid in the vicinity of each nozzle 15 is exposed to air is long. The viscosity of liquid thus increases, deteriorating the discharge performance.

In order to solve that problem, in the first embodiment, when the setting processing time is set to the second setting time, non-discharge flushing (an operation for making the liquid in each nozzle 15 vibrate without discharging the liquid) is executed in the setting processing. The non-discharge flushing is executed during the movement from the standstill position PA20 to the position PA21 to obtain a good recovery effect of the discharge performance.

Accordingly, even when the setting processing time is long, the liquid in each nozzle 15 is stirred or agitated effectively and fresh liquid is discharged. The liquid discharge apparatus 1 may include a sensor configured to measure an ambient condition, such as a temperature sensor and a humidity sensor. For example, the viscosity of liquid easily increases as the temperature is higher. In that case, the controller 40 may increase the frequency of the non-discharge flushing. Similarly, the viscosity of liquid easily increases as the humidity is lower. In that case, the controller 40 may increase the frequency of the non-discharge flushing.

<Improvement in Accuracy of Sheet Conveyance>

In the first embodiment, when the setting processing time is set to the second setting time, the conveyance velocity of the recording sheet P may be lower than that of when the setting processing time is set to the first setting time. This enhances the conveyance precision of the recording sheet P, thus improving quality of an image obtained by the recording processing immediately after the setting processing.

<Use of Liquid Droplet Having Large Diameter>

In the recording processing of the first embodiment, the liquid droplet size to be discharged is determined for each pixel based on image data memorized in the RAM 43. In that configuration, when the next pass is the second state pass, the controller 40 may change at least image data for the starting position in the recording processing for the next pass. Specifically, the liquid droplet to be discharged in that position may be allowed to have a size larger than a value indicated by the image data.

Since the liquid droplet discharged at the starting position of the recording processing has a large size, the liquid droplet is not susceptible to the airflow. The setting processing time is thus set to be shorter by shortening the waiting time, etc. This inhibits the thickening of liquid, thus inhibiting unnecessary extension of the printing time.

<Size of Affected Area>

In the first embodiment, the size of the affected area (the length in the main scanning direction) may be set to be short as appropriate based on various viewpoints described below.

(1. Nozzle Rows)

As depicted in FIG. 3, multiple nozzle rows 16 are arranged on the nozzle surface of the liquid discharge head 13 with intervals in the main scanning direction. Here, the size of the affected area may be set for each nozzle row. Specifically, the nozzle row 16 positioned more upstream in the moving direction of the carriage 12 in the recording processing may have a smaller affected area.

For example, when the liquid droplets land on the same position, the liquid droplets discharged from mutually different nozzle rows 16 have mutually different effects from the airflow. Since the different nozzle rows 16 face different partial airflows of the airflow at the above same position, the effects from the airflow vary. A certain partial airflow faces the nozzle row 16 positioned at a downstream side in the moving direction of the carriage 12 (a direction along the main scanning direction), and then faces the nozzle row 16 positioned at an upstream side in the moving direction of the carriage 12.

The upstream-side nozzle row 16 and the downstream-side nozzle row 16 reach the above same position at different points in time during movement of the carriage 12. The time difference weakens the airflow, and thus the upstream-side nozzle row 16 faces weakened airflow (a partial airflow following the certain partial airflow). The airflow is brought into contact with the nozzle surface for a long time until each nozzle row 16 reaches the above same position. The airflow is further weakened by being brought into contact with the nozzle surface, and thus the upstream-side nozzle row 16 faces airflow further weakened.

Accordingly, the effect of the airflow on the liquid droplets from the upstream-side nozzle row 16 is smaller than that on the liquid droplets from the downstream-side nozzle row 16. The affected area corresponding to the upstream-side nozzle row 16 may have a size in the main scanning direction smaller than that of the affected area corresponding to the downstream-side nozzle row 16. Making the size of the affected area small reduces the frequency of adjustment of the setting processing time. This results in speedy image formation without deteriorating the image quality.

(2. Printing Mode)

The liquid discharge apparatus 1 includes multiple kinds of recording modes. The moving velocity of the liquid discharge had 13 depends on each of the recording modes. For example, although an image having a high image quality is formed using a fine mode, the liquid discharge head 13 moves at low velocity. Although an image having a low image quality is formed using a draft mode, the liquid discharge head 13 moves at high velocity. An image having a normal image quality is formed using a normal mode, and the liquid discharge head 13 moves at normal velocity.

The liquid discharge apparatus 1 moves the liquid discharge head 13 in the second direction at velocity depending on the recording mode. Namely, regarding the moving velocity of the liquid discharge head 13 in the setting processing when the liquid discharge head 13 moves to the standstill position immediately before the recording processing is executed, the draft mode has the fastest velocity, the normal mode has the second fastest velocity, and the fine mode has the lowest velocity. Corresponding to this, the draft mode has the strongest residual airflow, the normal mode has the second strongest airflow, and the fine mode has the weakest residual airflow.

In view of the above, the liquid discharge apparatus 1 includes affected areas having different sizes depending on the respective recording modes. The size of the affected area is smaller as the moving velocity when the liquid discharge head 13 moves to the standstill position immediately before the recording processing is executed is lower. For example, the size of the affected area when using the fine mode may be smaller than that when using the normal mode or the draft mode. This allows the affected area to have an appropriate size depending on the recording mode. Namely, the affected area having a small size is used in the case of the recording mode having low velocity. This reduces the frequency of adjustment of the setting processing time, resulting in speedy image formation without deteriorating the image quality.

(3. Width of Recording Sheet)

The liquid discharge apparatus 1 can perform printing on multiple kinds of recording sheets P having different sizes (width dimensions) in the main scanning direction. The liquid discharge head 13 moves to the standstill position over a longer distance immediately before the recording processing is executed as the width dimension of the recording sheet P is larger. The residual airflow has a greater effect on the following recording processing as the distance over which the liquid discharge head 13 moves is longer.

In view of the above, the liquid discharge apparatus 1 includes affected areas having different sizes depending on the width directions of the recording sheets P. The size of the affected area to be set is smaller as the width dimension of the recording sheet P is smaller. This allows the setting processing time to be set depending on the width dimension of the recording sheet P, making it possible to perform printing in time corresponding to the width dimension of the recording sheet P. Namely, when the width dimension of the recording sheet P is small, the size of the affected area is small. This reduces the frequency of adjustment of the setting processing time, resulting in speedy image formation without deteriorating the image quality.

(4. Image Size)

When the preceding recording processing is completed, the liquid discharge apparatus 1 reverses the moving direction of the liquid discharge head 13 and the liquid discharge head 13 moves to a starting position for the succeeding recording processing. For example, in FIG. 5, the liquid discharge head 13 moves in the main scanning direction from the position PA13 to the position PA20 where the liquid discharge head 13 stops. The residual airflow has a greater effect on the succeeding recording processing as the distance over which the liquid discharge head 13 moves is longer. This movement distance depends on the size of the image formed in the preceding recording processing.

In view of the above, the liquid discharge apparatus 1 changes the size of the affected area depending on the moving distance between the two standstill positions in the setting processing. In that case, the setting processing time is set depending on the size of the image formed in the preceding recording processing. Namely, when the size of the formed image is small, the size of the affected area is small. This reduces the frequency of adjustment of the setting processing time, resulting in speedy image formation without deteriorating the image quality.

(5. Borderless Printing)

The liquid discharge apparatus 1 can execute the recording processing using a borderless mode. In the borderless mode, a range where an image can be formed extends beyond the outsides of the recording sheet P in the main scanning direction.

Namely, in the borderless mode, each liquid droplet lands on the outside of the recording sheet P in the vicinity of the starting position of the recording processing. Thus, when the continuous area is included in the area positioned outside the recording sheet P, the image quality is hardly affected thereby. The areas positioned outside the recording sheet P in the main scanning direction may thus be removed from the affected area when using the borderless mode. This makes the affected area of the borderless mode smaller than that of the normal mode, avoiding unnecessary waiting time. Further, speedy image formation is achieved without deteriorating the image quality.

<Arrangement of Nozzle Rows>

In the first embodiment, the liquid discharge apparatus 1 executes the unidirectional printing. In that case, the liquid discharge head 13 is preferably configured as follows. The nozzle row 16 from which an achromatic liquid (e.g., black ink) is discharged or the nozzle row 16 from which a liquid having high luminosity (e.g., yellow ink) is discharged is disposed at a downstream side in the first direction of the main scanning direction from the nozzle row 16 from which any other color of liquid (e.g., cyan or magenta ink) is discharged.

Namely, when an image having a high image quality (e.g., a photo) is printed, the frequency of use of the achromatic liquid is lower than the frequency of use of the remaining other liquids. Therefore, with respect to the achromatic liquid, the affected area is not likely to include the continuous area. This reduces the frequency of adjustment of the setting processing time, resulting in speedy image formation without deteriorating the image quality.

A user has difficulty in visually observing the liquid having high luminosity compared to a liquid having low luminosity. Thus, even when the nozzle row 16 from which the liquid having high luminosity is discharged is disposed at the downstream side in the first direction, the landing failure of liquid droplets is inconspicuous and substantial image deterioration is hardly caused.

### Second Embodiment

When the residual airflow passes under the nozzle surface, it mostly flows in the main scanning direction in the vicinity of a center portion in the sub-scanning direction of the nozzle surface. The vicinities of ends in the sub-scanning direction of the nozzle surface include not only a component of the main scanning direction but also a component of the sub-scanning direction. Thus, liquid droplets discharged from the ends in the sub-scanning direction of each nozzle row 16 may deviate in the sub-scanning direction from a strip-like or belt-like recording area that is long in the main scanning direction. One image is completed by connecting or seaming, in the sub-scanning direction, the belt-like recording areas that is long in the main scanning direction. The seamed or connected portion formed by the belt-like recording areas may thus suffer from the landing failure multiple times, making the deterioration in image quality conspicuous. In view of the above, in the second embodiment, the deterioration in image quality is avoided by setting the setting processing time as described below.

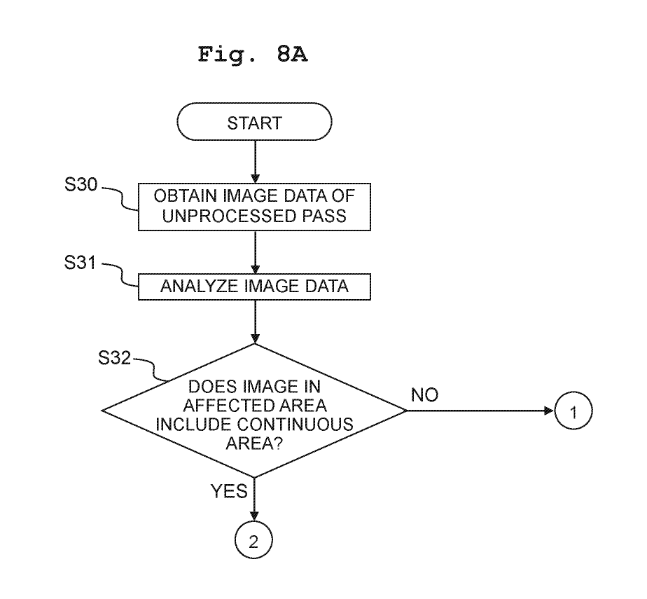

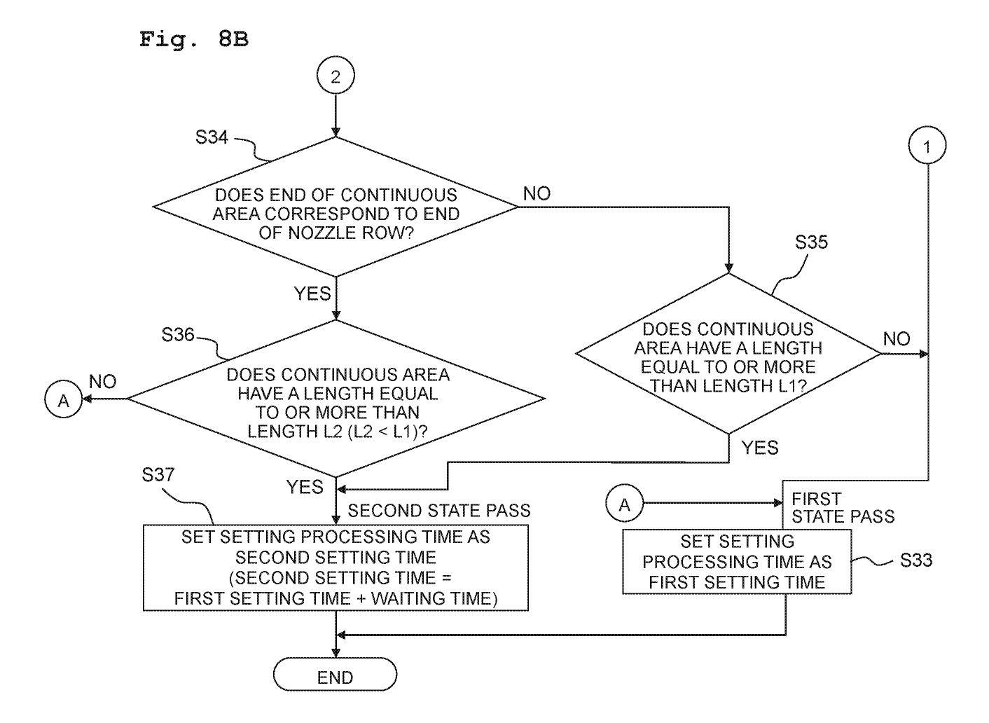

Referring to FIGS. 8A and 8B, an exemplary procedure for setting the setting processing time according to the second embodiment is explained. The controller 40 obtains image data of an unprocessed pass (step S30). The image data of the unprocessed pass typically corresponds to image data for the next recording processing. In a step S31, the controller 40 analyzes the image data to extract a continuous area. In a step S32, the controller 40 determines whether an image in an affected area includes the continuous area.

When the continuous area is not included in the affected area (S32: NO), the controller 40 sets the setting processing time as the first setting time (step S33). When the continuous area is included in the affected area (S32: YES), the controller 40 proceeds to a step S34.

In the step S34, the controller 40 determines whether an end or both ends of the continuous area correspond(s) to an end or both ends of the nozzle row 16. When the end or both ends of the continuous area does/do not correspond to the end or both ends of the nozzle row 16 (S34: NO), the controller 40 proceeds to a step 535. Similar to the step S24 of FIG. 6, the controller 40 determines in the step S35 whether the continuous area has a length equal to or more than the length L1 in the sub-scanning direction. When the length in the sub-scanning direction of the continuous area is less than the length L1 (S35: NO), the controller 40 sets the setting processing time as the first setting time (S33). When the length in the sub-scanning direction of the continuous area is equal to or more than the length L1. (S35: YES), the controller 40 proceeds to a step S37.

In the step S37, the controller 40 sets the setting processing time as the second setting time (=the first setting time+waiting time), which is longer than the first setting time.

When the controller 40 has determined in the step S34 that the end or both ends of the continuous area correspond(s) to the end or both ends of the nozzle row 16 (S34: YES), the controller 40 proceeds to a step S36. In the step S36, the controller 40 determines whether the continuous area has a length equal to or more than a length L2 in the sub-scanning direction. The length L2 is shorter than the length L1. For example, the length L2 may be, for example, 0.8 mm (<the length L1 having a length of 1.0 mm).

When the controller 40 has determined in the step S36 that the length of the continuous area is less than the length L2 (S36: NO), the controller 40 sets the setting processing time as the first setting time (S33). When the controller 40 has determined in the step S36 that the length of the continuous area is equal to or more than the length L2 (S36: YES), the controller 40 proceeds to the step S37 and sets the setting processing time as the second setting time (=the first setting time+waiting time).

As described above, when the end or both ends of the continuous area correspond(s) to the end or both ends of the nozzle row 16, the controller 40 sets the setting processing time by using the length L2 (<L1) shorter than the length L1 as a threshold value. This inhibits the landing failure of liquid droplets that may otherwise be caused multiple times in the seamed or connected portion of the belt-like recording areas, thus maintaining a high image quality.

### Other Embodiments

The liquid discharge apparatus 1 may execute the recording processing when the liquid discharge head 13 moves in both one direction and the other direction of the main scanning direction. Namely, the liquid discharge apparatus 1 may be configured to execute bidirectional printing.

In the bidirectional printing, the setting processing is an operation of the liquid discharge head 13 that is executed after the recording processing for the preceding pass is completed until the recording processing for the succeeding pass is started. The time during which the setting processing is executed is the set processing time. In the bidirectional printing, the setting processing includes one standstill position where the liquid discharge head 13 reverses the moving direction.

In the bidirectional printing, the liquid discharge apparatus 1 may set the setting processing time based on the procedure indicated in FIG. 6 or FIGS. 8A, 8B. This inhibits the landing failure of liquid droplets due to the airflow similarly to the above embodiment. Namely, when the next pass is the second state pass, the liquid discharge head 13 takes the second setting time in the setting processing by executing the waiting processing or moving the liquid discharge head 13 at low velocity. This weakens the residual airflow, which inhibits the landing failure of liquid droplets in the next recording processing.

In the bidirectional printing, the liquid discharge head 13 may begin to decelerate in the middle of the recording processing for one pass. This weakens the residual airflow, which inhibits the landing failure of liquid droplets and shortens the setting processing time.

What is claimed is:

1. A liquid discharge apparatus, comprising:
a discharge head including a plurality of nozzles;
a head scanning mechanism configured to reciprocatingly move the discharge head in a main scanning direction;
a conveyer configured to convey a recording medium in a sub-scanning direction orthogonal to the main scanning direction; and
a controller configured to control the discharge head, the head scanning mechanism, and the conveyer;
wherein the controller is configured to execute, in one pass,
recording processing in which an image is formed on the recording medium by moving the discharge head in the main scanning direction and discharging liquid from the discharge head,
setting processing, taking setting processing time and executed after completion of the recording processing, in which the discharge head is moved from an ending position of the recording processing for the one pass to a starting position of the recording processing for a pass following the one pass by changing a moving direction of the discharge head at a standstill position, without discharging the liquid from the discharge head, and
conveyance processing in which the recording medium is conveyed in the sub-scanning direction,
wherein the controller is further configured to:
set the setting processing time required for the setting processing for the one pass as a first setting time in a case that the pass following the one pass is a first state pass, and
set the setting processing time required for the setting processing for the one pass as a second setting time in a case that the pass following the one pass is a second state pass, the second setting time being obtained by adding a waiting time to the first setting time, the second state pass being different from the first state pass.

2. The liquid discharge apparatus according to claim 1,
wherein, in the first state pass, a continuous area having a length of equal to or more than a first length in the sub-scanning direction is not formed in an affected area, and
wherein, in the second state pass, the continuous area having the length of equal to or more than the first length in the sub-scanning direction is formed in the affected area.

3. The liquid discharge apparatus according to claim 2,
wherein the plurality nozzles form a nozzle row extending in the sub-scanning direction,
wherein the affected area is an area ranging from a nozzle position to a boundary position,
wherein the nozzle position is a position where the nozzle row is positioned in a case that the discharge head is in the standstill position, and
wherein the boundary position is a position separated from the nozzle position in a moving direction of the discharge head after the change in the moving direction by a predefined distance.

4. The liquid discharge apparatus according to claim 3, further comprising a memory configured to store image data of an image to be formed on the recording medium,
wherein the continuous area is a partial image, of the image, formed by a plurality of pixels arranged in the sub-scanning direction at unit intervals corresponding to resolution in the sub-scanning direction.

5. The liquid discharge apparatus according to claim 3, wherein the first length is 1.0 mm.

6. The liquid discharge apparatus according to claim 1, wherein the waiting time is in a range of equal to or more than 0.1 second and equal to or less than 1.0 seconds.

7. The liquid discharge apparatus according to claim 1,
wherein, in the recording processing, the controller is configured to move the discharge head in a first direction, along the main scanning direction,
wherein in the case that the pass following the one pass is the second state pass, in the setting processing for the one pass, the controller is configured to move the discharge head in the first direction to the standstill position and to stop the discharge head at the standstill position for the waiting time, and
wherein, after the setting processing for the one pass is completed, the controller is configured to move the discharge head in a second direction opposite to the first direction to execute the recording process for the pass following the one pass.

8. The liquid discharge apparatus according to claim 7,
wherein the controller is configured to execute non-discharge flushing during movement of the discharge head from the standstill position to the starting position of the recording processing for the pass following the one pass, and
wherein in the non-discharge flushing, the controller is configured to control the discharge head to vibrate the liquid in the nozzles without discharging the liquid from the nozzles.

9. The liquid discharge apparatus according to claim 1, wherein in the case that the pass following the one pass is the second state pass, after the recording processing for the one pass is completed, the controller is configured to decrease a moving velocity of the discharge head in the setting processing for the one pass such that the discharge head is moved to the standstill position while taking a time longer than the first setting time.

10. The liquid discharge apparatus according to claim 1,
wherein the discharge head includes a plurality of nozzle rows,
wherein the plurality of nozzle rows are arranged in the main scanning direction at spaced intervals,
wherein the plurality of nozzle rows include a first nozzle row and a second nozzle row that is positioned downstream of the first nozzle row in a moving direction of the discharge head after the change in the moving direction,
wherein, in the first state pass, a continuous area having a length of equal to or more than a first length in the sub-scanning direction is not formed in a first affected area and a second affected area, the first affected area corresponding to the first nozzle row and the second affected area corresponding to the second nozzle row,
wherein, in the second state pass, the continuous area having the length of equal to or more than the first length in the sub-scanning direction is formed in the first affected area and the second affected area, and
wherein the controller is configured to make a length in the main scanning direction of the first affected area shorter than a length in the main scanning direction of the second affected area.

11. The liquid discharge apparatus according to claim 2, wherein the controller is configured to make a length in the main scanning direction of the affected area shorter as a moving velocity in the main scanning direction of the discharge head in the recording processing is slower.

12. The liquid discharge apparatus according to claim 2, wherein the controller is configured to make a length in the main scanning direction of the affected area shorter as a width in the main scanning direction of the recording medium is smaller.

13. The liquid discharge apparatus according to claim 2, wherein the controller is configured to make a length in the main scanning direction of the affected area for the pass following the one pass shorter as a width in the main scanning direction of the image to be formed in the recording processing for the one pass is smaller.

14. The liquid discharge apparatus according to claim 2,
wherein the liquid discharge apparatus is configured to execute a borderless mode in which an image having a width that is the same as or larger than a width in the main scanning direction of the recording medium is formed or a normal mode in which an image having a width that is smaller than the width in the main scanning direction of the recording medium is formed, and
wherein a length in the main scanning direction of the affected area when the borderless mode is executed is set to be shorter than that when the normal mode is executed.

15. The liquid discharge apparatus according to claim 3,
wherein in a case that an end in the sub-scanning direction of the continuous area included in the affected area corresponds to an end of the nozzle row or both ends in the sub-scanning direction of the continuous area included in the affected area correspond to both ends of the nozzle row, the controller is configured to determine whether a length in the sub-scanning direction of the continuous area is equal to or more than a second length that is shorter than the first length,
wherein in a case that the controller has determined that the length in the sub-scanning direction of the continuous area is equal to or more than the second length, the controller is configured to determine that the pass following the one pass is the second state pass, and
wherein in a case that the controller has determined that the length in the sub-scanning direction of the continuous area is less than the second length, the controller is configured to determine that the pass following the one pass is the first state pass.

16. The liquid discharge apparatus according to claim 1, wherein in the case that the pass following the one pass is the second state pass, the controller is configured to control the discharge head to discharge a liquid droplet of the liquid having a diameter that is larger than a diameter determined based on the image data from each of the nozzles at the starting position.

17. The liquid discharge apparatus according to claim 1, wherein in the case that the pass following the one pass is the second state pass, the controller is configured to control the conveyer to make a conveyance velocity of the recording medium in the conveyance processing slower than the case in which the pass following the one pass is the first state pass.

18. The liquid discharge apparatus according to claim 1, wherein, in the recording processing, the controller is configured to move the discharge head only in one direction along the main scanning direction.

19. The liquid discharge apparatus according to claim 18, wherein in the case that the pass following the one pass is the second state pass, in the setting processing for the one pass, the controller is configured to move the discharge head to the standstill position and to stop the discharge head at the standstill position for the waiting time.

20. The liquid discharge apparatus according to claim 18,
wherein the discharge head includes a plurality of nozzle rows,
wherein the plurality of nozzle rows are arranged in the main scanning direction at spaced intervals,
wherein the plurality of nozzle rows include a first nozzle row and a second nozzle row that is positioned downstream of the first nozzle row in a moving direction of the discharge head after the change in the moving direction,
wherein an achromatic liquid or a liquid having high luminosity is discharged from the second nozzle row, and
wherein any other color of liquid is discharged from the first nozzle row.

21. The liquid discharge apparatus according to claim 1, wherein in the recording processing, the controller is configured to move the discharge head in a first direction and a second direction opposite to the first direction, along the main scanning direction.

22. The liquid discharge apparatus according to claim 21, wherein the controller is configured to begin to decrease a moving velocity of the discharge head in the recording processing.

23. The liquid discharge apparatus according to claim 1, wherein in the case that the pass following the one pass is the second state pass, after the recording processing for the one pass is completed, the controller is configured to stop the discharge head at the standstill position for spending the waiting time.
